(19) United States
(12) Patent Application Publication
(10) Pub. No.: US 2007/0205026 A1
(43) Pub. Date: Sep. 6, 2007

(54) Traveling system for heavy construction equipment

(75) Inventor: Jae Hoon Lee, Kyungsangnam-do (KR)

Correspondence Address: William R. Evans;Ladas & Parry LLP, 26 West 61 Street, New York, NY, 10023, US

(73) Assignee: VOLVO CONSTRUCTION EQUIPMENT HOLDING SWEDEN AB.

(21) Appl. No.: 11/498,324

(22) Filed: Aug. 2, 2006

(30) Foreign Application Priority Data
Aug. 2, 2005 (KR) 10-2005-70672

(51) Int. Cl. B62D 11/02; B62D 11/00

(52) U.S. Cl. 180/6.48

(57) ABSTRACT

A traveling system for heavy construction equipment is disclosed, which can prevent a flow rate of a hydraulic fluid to be supplied to a traveling spool from being suddenly decreased when a traveling device and a working device are simultaneously operated, and thus can minimize operation shock due to sudden reduction in traveling speed. The traveling system includes a sensing device that detects manipulation of an operation lever of the working device or manipulation of a traveling pedal installed in the operation lever or the traveling pedal and outputs an electric signal to a controller in a specific operation mode. The traveling system also includes first and second variable displacement hydraulic pumps that are driven by an engine and have the same maximum capacity and a main control valve that controls the flow direction of a hydraulic fluid discharged from the hydraulic pumps.

### CROSS-REFERENCE TO RELATED APPLICATION

This application is based on and claims priority from Korean Patent Application No. 10-2005-70672, filed on Aug. 2, 2005, the disclosure of which is incorporated herein in its entirety by reference.

### BACKGROUND OF THE INVENTION

1. Field of the Invention

The present invention relates to a traveling system, and more particularly, to a traveling system for heavy construction equipment that can prevent a flow rate of a hydraulic fluid to be supplied to a traveling spool from being suddenly decreased when a traveling device and a working device are simultaneously operated, by installing a sensing device that detects manipulation of an operation lever of the working device or manipulation of a traveling pedal in the operation lever or the traveling pedal, and enabling the sensing device to output an electric signal to a controller in a specific operation mode.

2. Description of the Prior Art

FIGS. 1 and 2 are hydraulic circuit diagrams of conventional traveling systems.

Referring to FIG. 1, the conventional traveling system includes first and second variable displacement hydraulic pumps 12 and 42, respectively, that are driven by an engine and having the same maximum capacity, electric proportional control valves 28 and 58 controlling the capacities of the hydraulic pumps 12 and 42, respectively, a pilot pump 60 that feeds pilot pressure to the electric proportional control valves 28 and 58 and spools for driving various actuators, a controller 62 that outputs electric signals to the electric proportional control valves .28 and 58 and an electric control valve 90, and a main control valve 70, installed between the hydraulic pumps 12 and 42 and a working device/traveling motor (not shown), that controls the flow direction of a hydraulic fluid discharged from the hydraulic pumps 12 and 42.

The main control valve 70 includes a left traveling spool 74, connected to the hydraulic pumps 12 and 42, for controlling startup/stop of a left traveling motor (not shown) that drives a traveling device through a left traveling operation pedal 72 to control the flow direction of the hydraulic fluid to be supplied to the left traveling motor, and a right traveling spool 78, connected to the hydraulic pumps 12 and 42, for controlling startup/stop of a right traveling motor (not shown) that drives the traveling apparatus through a right traveling operation pedal 76 to control the flow direction of the hydraulic fluid to be supplied to the right traveling motor.

The main control valve 70 also includes a spool 82 of a left traveling-side working device controlling a flow direction of the hydraulic fluid to be supplied to the working device by controlling startup/stop of a hydraulic actuator (not shown) that drives the working device through an operation lever 80 manipulating the left traveling spool-side working device, a spool 86 of a right traveling-side working device controlling a flow direction of the hydraulic fluid to be supplied to the working device by controlling startup/stop of the hydraulic actuator (not shown) driving the working device through an operation lever 84 manipulating the right traveling spool-side working device, and a straight traveling spool 88 preventing only one of left and right traveling spools from driving when the traveling device and the working device are simultaneously operated.

The traveling system further includes an electric control valve 90 that feeds the pilot pressure to the straight traveling spool 88 to shift the spool when the traveling motor and the hydraulic actuators are simultaneously operated.

However, the conventional traveling system as described above has the following problems.

When only the traveling device is operated, the straight traveling spool 88 is not shifted. However, when the traveling device and the working device are simultaneously operated, the pilot pressure Pi is fed to the straight traveling spool 88 via the electric control valve 90.

Therefore, when only the traveling device is driven, the hydraulic fluid is supplied from the first hydraulic pump 12 to the left traveling spool 74 and from the second hydraulic pump 42 to the right traveling spool 78 via the straight traveling spool 88.

When the traveling device and the working device are simultaneously operated, the pilot pressure Pi is fed to the straight traveling spool 88, shifting the straight traveling spool 88 to the right. The hydraulic fluid discharged from the first hydraulic pump 12 is supplied to the left traveling spool 74, and simultaneously, is supplied to the right traveling spool 78 via the straight traveling spool 88. Meanwhile, the hydraulic fluid discharged from the second hydraulic pump 42 is supplied to the spools 82 and 86 for the working device. Consequently, straight travel can be obtained.

More specifically, when the spool 86 of the right traveling-side working device is operated by the operation lever 84 manipulating the right traveling spool-side working device, the hydraulic fluid discharged from the second hydraulic pump 42 is supplied via a line A. When the spool 82 of the left traveling-side working device is operated by the operation lever 80 manipulating the left traveling spool-side working device, the hydraulic fluid discharged from the second hydraulic pump 42 is supplied via a line B.

When the traveling device and the working device are simultaneously operated, the flow rate of the hydraulic fluid supplied to the left traveling spool 74 and the right traveling spool 78 is reduced by half; therefore, the traveling speed is also cut in half, causing the driver to be shocked by such sudden deceleration.

In order to solve the problem, as shown in FIG. 2, a line C is branched from the line A among the lines connected to the second hydraulic pump 42, and a fixed orifice 92 is added to the branch line C. Thus, even though the traveling device and the working device are simultaneously operated, a part of the hydraulic fluid supplied to the working device is supplied to the traveling device, thereby preventing the traveling speed from being suddenly decreased.

However, when the load pressure of the working device is much higher than that of the traveling device (e.g., lifting work), most of the hydraulic fluid which should be supplied to the working device is supplied to the traveling device. Therefore, the working device is not operated, and only the traveling speed is increased, so the manipulation is deteriorated, and the possibility of erroneous manipulation is increased.

### SUMMARY OF THE INVENTION

Accordingly, the present invention has been made to solve the above-mentioned problems occurring in the prior art. One object of the present invention is to provide a traveling system for heavy construction equipment that can prevent traveling speed from being suddenly decreased when a traveling device and a working device are simultaneously operated.

Another object of the present invention is to provide a traveling system for heavy construction equipment that can prevent traveling speed from being suddenly decreased, without interfering with the operation of a working device, when the load pressure of the working device is higher than that of the traveling device while the traveling device and the working device are simultaneously operated.

In order to accomplish these objects, there is provided a traveling system for heavy construction equipment that includes first and second variable displacement hydraulic pumps with the same maximum capacity that are driven by an engine; electric proportional control valves that control the capacities of the hydraulic pumps; a pilot pump that feeds pilot pressure to the electric proportional control valves; a controller that outputs electric signals to the electric proportional control valves; a main control valve that controls the flow direction of a hydraulic fluid discharged from the hydraulic pumps, having left and right traveling spools connected to the hydraulic pumps that control the flow direction of a hydraulic fluid to be supplied to the left and right traveling motors by controlling startup/stop of the left and right traveling motors which drive a traveling device through left and right traveling operation pedals, at least one working device spool that controls the flow direction of a hydraulic fluid to be supplied to a working device by controlling startup/stop of a hydraulic actuator driving the working device through a working device operation lever, and a straight traveling spool that obtains a straight drive of the equipment when the traveling device and the working device are simultaneously operated; an electric control valve that feeds pilot pressure to the straight traveling spool to shift the straight traveling spool when the left and right traveling motors and the hydraulic actuator are simultaneously operated; a sensing device that detects manipulation of the left and right traveling operation pedals to output an electric signal; a sensing device that detects manipulation of the working device operation lever to output an electric signal; and a mode selection device, installed on one side of the controller, for selecting a specific mode.

If the standard mode is selected by the mode selection device, the first hydraulic pump and the second hydraulic pump discharge the hydraulic fluid at a flow rate in proportion to manipulation amounts of the traveling operation pedals and the working device operation levers. If the traveling operation pedals and the working device operation levers are manipulated to an end of stroke, the hydraulic pumps discharge the hydraulic fluid at a maximum flow rate, causing the traveling motor and the hydraulic actuator to operate at a maximum speed. If a specific mode is selected by the mode selection device, the hydraulic pump discharges the hydraulic fluid at a flow rate corresponding to the manipulation amount of the operation lever when only the traveling device is operated; when only the traveling device is operated, the hydraulic pump discharges the hydraulic fluid at the flow rate corresponding to the manipulation amount of the pedal. Although the pedal or the operation lever is manipulated to the end of stroke, the hydraulic pump does not discharge the hydraulic fluid at the maximum discharge rate but discharges the hydraulic fluid at a predetermined discharge rate. If the left and right traveling devices and the working device are simultaneously operated, the controller receives the signals from the sensing devices for detecting manipulation of the left and right traveling operation pedals and the sensing devices for detecting manipulation of the manipulation levers of the left and right traveling spool-side working devices, and maximizes the discharge rate of the hydraulic fluid discharged from the hydraulic pumps.

If the straight traveling spool is in a neutral mode, one side of the supply ports of the main control valve is connected to the left traveling spool and the spool of the left traveling-side working device, which is connected in series or in parallel with the left traveling spool, and the other side of the supply ports of the main control valve is connected to the right traveling spool and the spool of the right traveling-side working device, which is connected in series or in parallel with the right traveling spool.

The sensing device for detecting manipulation of the traveling operation pedals is composed of a sensing device that detects manipulation of the left traveling operation pedal, and a sensing device detecting manipulation of the right traveling operation pedal.

The sensing device for detecting manipulation of the traveling operation pedals is to detect manipulation of the left and right traveling operation pedals.

The sensing device for detecting the manipulation of the working device operation lever is to detect manipulation of the working device.

The sensing device for detecting the manipulation of the working device operation lever is to detect whether the working device spool is driven by at least one of the working device operation levers.

The sensing device for detecting manipulation of the traveling operation pedals and the sensing device for detecting the manipulation of the working device operation lever are to detect whether the left and right traveling operation pedals and at least one of the working device operation levers are simultaneously operated.

Preferably, the sensing device includes a pressure switch.

Preferably, the sensing device includes a pressure sensor.

At least one of the traveling operation pedals or working device operation levers uses an electric pedal or an electric operation lever, so that an output voltage of the pedal or operation lever is detected to detect manipulation of the traveling operation pedals or manipulation of the working device operation levers.

The electric control valve is a solenoid valve.

The electric control valve is an electric proportional valve.

According to another aspect of the present invention, there is provided a traveling method for heavy construction equipment, which includes selecting a standard mode by using a mode selection device; when only a traveling device is operated, hydraulic fluid is supplied from a first hydraulic pump to a left traveling spool and from a second hydraulic pump to a right traveling spool via a straight traveling spool so that the first hydraulic pump and the second hydraulic pump discharge the hydraulic fluid at a flow rate in proportion to manipulation amounts of traveling operation pedals; when only a working device is operated, hydraulic fluid is supplied from the first hydraulic pump to a spool for a left traveling-side working device and from the second hydraulic pump to a spool for a right traveling-side working device via a straight traveling spool so that the first hydraulic pump and the second hydraulic pump discharge the hydraulic fluid at a flow rate in proportion to manipulation amounts of working device operation levers; when the traveling operation pedals and the working device operation levers are manipulated to an end of stroke, hydraulic fluid is discharged from the hydraulic pumps at a maximum flow rate so that a traveling motor and a hydraulic actuator operate at a maximum speed; selecting a specific mode by using the mode selection device; and discharging the hydraulic fluid at a flow rate corresponding to the manipulation amount of the operation lever if only the traveling device is operated, discharging the hydraulic fluid at a flow rate corresponding to the manipulation amount of the pedal if only the traveling device is operated, wherein although the pedal or the operation lever is manipulated to the end of stroke, the hydraulic pump does not discharge the hydraulic fluid at the maximum discharge rate but discharges the hydraulic fluid at a predetermined discharge rate, and a controller receiving signals from sensing devices detecting manipulation of the left and right traveling operation pedals and sensing devices detecting manipulation of the manipulation levers of the left and right traveling spool-side working devices, and maximizing the discharge rate of the hydraulic fluid discharged from the hydraulic pumps, if the left and right traveling devices and the working device are simultaneously operated.

With the construction as described above, the traveling system of the present invention can prevent a traveling speed from being suddenly decreased.

### BRIEF DESCRIPTION OF THE DRAWINGS

The above and other objects, features and advantages of the present invention will be more apparent from the following detailed description taken in conjunction with the accompanying drawings, in which:

FIG. 1 is a hydraulic circuit diagram of a conventional traveling system;

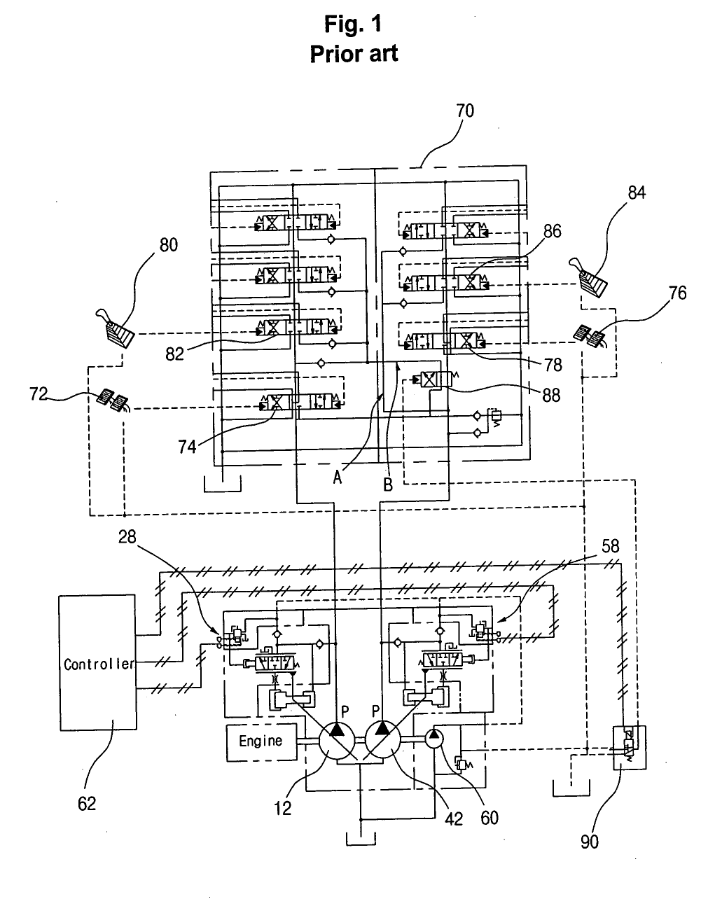

FIG. 2 is a hydraulic circuit diagram of another conventional traveling system; and

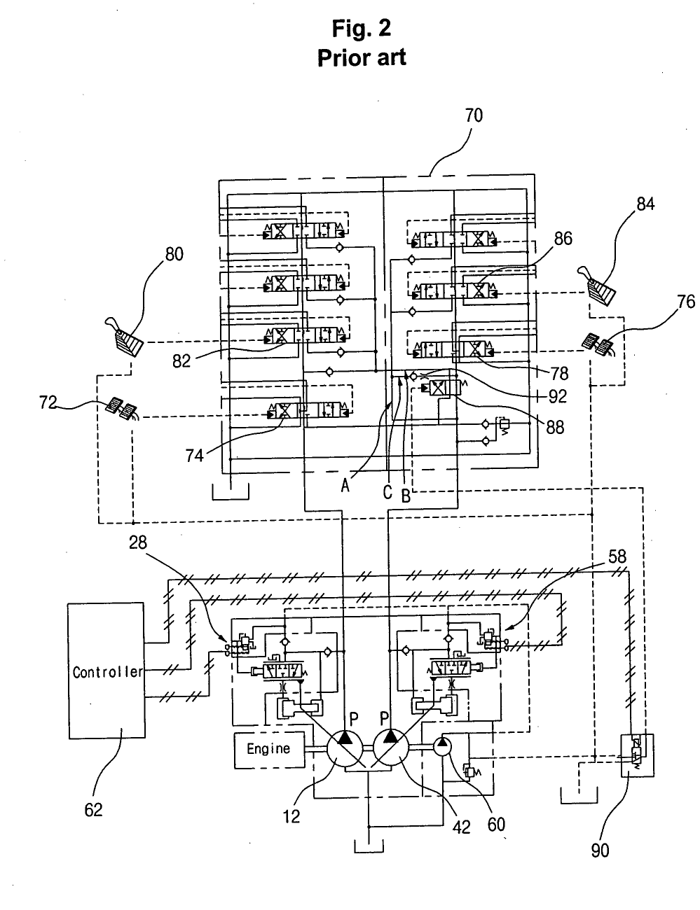

FIG. 3 is a hydraulic circuit diagram of a traveling system according to an embodiment of the present invention.

### DETAILED DESCRIPTION OF THE PREFERRED EMBODIMENTS

Hereinafter, a preferred embodiment of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

The construction of a traveling system according to the present invention will now be described in detail with reference to preferred embodiments.

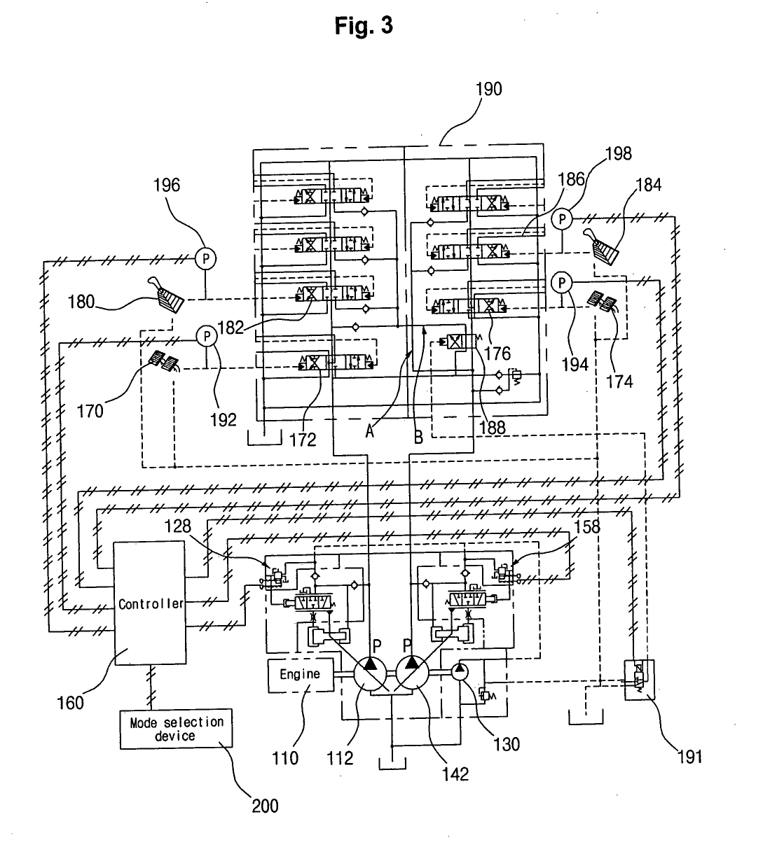

FIG. 3 is a hydraulic circuit diagram of a traveling system according to an embodiment of the present invention.

Referring to FIG. 3, the traveling system includes first and second variable displacement hydraulic pumps 112 and 142 driven by an engine 110 and having the same maximum capacity, electric proportional control valves 128 and 158 for controlling the capacities of the hydraulic pumps 112 and 142, respectively, a pilot pump 130 for feeding pilot pressure to the electric proportional control valves 128 and 158 and spools for driving various actuators, a controller 160 outputting an electric signals to the electric proportional control valves 128 and 158, a main control valve 190 for controlling the flow direction of a hydraulic fluid discharged from the hydraulic pumps 112 and 142. The traveling system also includes a left traveling operation pedal 170 connected to the hydraulic pumps 112 and 142 for controlling startup/stop of a left traveling motor (not shown) that drives a traveling device, a left traveling spool 172 for controlling the flow direction of a hydraulic fluid to be supplied to the left traveling motor in response to manipulation of the left traveling operation pedal 170, a right traveling operation pedal 174 connected to the hydraulic pumps 112 and 142 for controlling startup/stop of a right traveling motor (not shown) that drives the traveling apparatus, a right traveling spool 176 for controlling the flow direction of a hydraulic fluid to be supplied to the right traveling motor in response of manipulation of the right traveling operation pedal 174, a manipulation lever 180 of a left traveling spool-side working device for controlling startup/stop of a hydraulic actuator that drives a working device, a spool 182 of the left traveling-side working device for controlling the flow direction of a hydraulic fluid to be supplied to the working device in response to manipulation of the manipulation lever 180, a manipulation lever 184 of a right traveling spool-side working device for controlling startup/stop of the hydraulic actuator that drives the working device, a spool 186 of the right traveling-side working device for controlling the flow direction of the hydraulic fluid to be supplied to the working device in response to manipulation of the manipulation lever 184, and a straight traveling spool 188 for obtaining straight drive of the equipment when the traveling device and the working device are simultaneously operated. Moreover, the traveling device also includes an electric control valve 191 for feeding pilot pressure to the straight traveling spool 188 to shift the straight traveling spool 188 when the traveling device and the working device are simultaneously operated, a sensing device 192 for detecting manipulation of the left traveling operation pedal 170 to output an electric signal, a sensing device 194 for detecting manipulation of the right traveling operation pedal 174 to output an electric signal, a sensing device 196 for detecting manipulation of the manipulation lever 180 of the left traveling spool-side working device to output an electric signal, a sensing device 198 for detecting manipulation of the manipulation lever 184 of the right traveling spool-side working device to output an electric signal, and a mode selection device 200 driven by an operator for feeding pilot signal pressure discharged from the pilot pump 130 to the spools 172, 176, 182, and 186 in response to the manipulation of the operation pedal or the manipulation of the manipulation lever to control the traveling motor or the hydraulic actuator.

When the straight traveling spool 188 is in a neutral mode, one side of the supply ports of the main control valve 190 is connected to the left traveling spool 172 and the spool 182 of the left traveling-side working device, and the left traveling spool 172 and the spool 182 are connected in series or in parallel with each other. Also, the other side of the supply ports of the main control valve 190 is connected to the right traveling spool 176 and the spool 186 of the right traveling-side working device, and the right traveling spool 176 and the spool 186 are connected in series or in parallel with each other.

It is preferable that pressure switches or pressure sensors are used as the sensing devices 192, 194, 196, and 198. The sensing device for detecting manipulation of the traveling operation pedals is composed of the sensing device 192 for detecting manipulation of the left traveling operation pedal 170 and the sensing device 194 for detecting manipulation of the right traveling operation pedal 174. The sensing devices may be integrated as a single manipulation sensing device to detect the manipulation, when both left and right traveling operation pedals 170 and 174 are manipulated.

Also, the sensing device for detecting the manipulation of the working device operation lever is adapted to detect whether the working device is driven by at least one of the working device operation levers 180 and 184. The sensing devices may be integrated-into one device by use of the signal finally outputted when the left and right traveling operation pedals 170 and 174 and at least one of the working device operation levers 180 and 184 are simultaneously operated, and the operation of the traveling device and working device can be detected.

If an electric pedal or an electric operation lever is used as the traveling operation pedals 170 and 174 or the working device operation levers 180 and 184, the manipulation of the traveling operation pedals or the manipulation of the working device operation levers can be detected by detecting the voltage outputted from the pedal or operation lever, respectively.

In this embodiment, the electric control valve 191 is a solenoid valve, but an electric proportional valve may be used instead.

If a standard mode is selected by the mode selection device 200, the first hydraulic pump 112 and the second hydraulic pump 142 discharge the hydraulic fluid at the flow rate in proportion to the manipulation amounts of the traveling operation pedals 170 and 174 or the working device operation levers 180 and 184. If the traveling operation pedals 170 and 174 and the working device operation levers 180 and 184 are manipulated to an end of stroke, the pumps discharge the hydraulic fluid at a maximum flow rate, so that the traveling motor and the hydraulic actuator operate at a maximum speed.

If a specific mode is selected by the mode selection device 200, the hydraulic pump discharges the hydraulic fluid at the flow rate corresponding to the manipulation amount of the operation lever when only the traveling device is operated; when only the traveling device is operated, the hydraulic pump discharges the hydraulic fluid at the flow rate corresponding to the manipulation amount of the pedal. Although it is manipulated to the end of stroke, the hydraulic pump does not discharge the hydraulic fluid at the maximum discharge rate but discharges the hydraulic fluid at a predetermined discharge rate (e.g., about 70% of the maximum discharge rate). When the left and right traveling devices and the working device are simultaneously operated, the controller 160 receives the signals from the sensing devices 192 and 194 for detecting manipulation of the left and right traveling operation pedals and the sensing devices 196 and 198 for detecting manipulation of the manipulation levers of the left and right traveling spool-side working devices. Thus, when both left and right traveling operation pedals and an operation lever are all manipulated to their ends of stroke, the discharge rate of the hydraulic fluid discharged from the hydraulic pump is maximized.

Consequently, when the traveling speed is reduced to a certain level, e.g., from 70% of the maximum level to 50% of the maximum level, the driver or operator is not shocked by such sudden deceleration, so that the manipulation is maintained and the possibility of erroneous manipulation is minimized.

Also, when the load pressure of the working device is much higher than that of the traveling device, the hydraulic fluid to be supplied to the working device is not supplied to the traveling device, thereby preventing increase of the traveling speed that would cause operation shock.

The operation of the traveling system according to the present invention will now be described in detail with reference to the accompanying drawing.

When the standard mode is selected by the mode selection device 200 and only the traveling device is operated, the hydraulic fluid is supplied from the first hydraulic pump 112 to the left traveling spool 172 and also from the second hydraulic pump 142 to the right traveling spool 176 via the straight traveling spool 188. Thus, the hydraulic pumps 112 and 142 discharge the hydraulic fluid at a flow rate in proportion to the manipulation amounts of the traveling operation pedals 170 and 174.

When the specific mode is selected by the mode selection device 200 and only the working device is operated, the hydraulic fluid is supplied from the first hydraulic pump 112 to the spool 182 of the left traveling-side working device and also from the second hydraulic pump 142 to the spool 186 of the right traveling-side working device via the straight traveling spool 188. Thus, the hydraulic pumps 112 and 142 discharge the hydraulic fluid at a flow rate in proportion to the manipulation amounts of the manipulation levers 180 and 184.

Consequently, if the operation levers 180 and 184 and the pedals 170 and 174 are manipulated to the end of stroke, the hydraulic pumps discharge the hydraulic fluid at the maximum flow rate so that the traveling motor and the hydraulic actuator can operate at the maximum speed.

When the specific mode is selected by the mode selection device 200 and only the working device is operated, the hydraulic pump discharges the hydraulic fluid at a flow rate corresponding to the manipulation amount of the operation lever. When only the traveling device is operated, the hydraulic pump discharges the hydraulic fluid at a flow rate corresponding to the manipulation amount of the pedal. Although it is manipulated to the end of stroke, the hydraulic pump does not discharge the hydraulic fluid at the maximum discharge rate but discharges the hydraulic fluid at a predetermined discharge rate (e.g., about 70% of the maximum discharge rate). When the left and right traveling devices and the working device are simultaneously operated, the controller 160 receives the signals from the sensing devices 192 and 194 for detecting manipulation of the left and right traveling operation pedals and the sensing devices 196 and 198 for detecting manipulation of the manipulation levers of the left and right traveling spool-side working devices. Thus, when both left and right traveling operation pedals and an operation lever are all manipulated to their ends of stroke, the discharge rate of the hydraulic fluid discharged from the hydraulic pump is maximized. At that time, the electric control valve 191 is activated so that the straight traveling spool 188 is shifted.

As the above description, in order to prevent the flow rate of the hydraulic fluid to be supplied to the traveling spool from being suddenly decreased when the traveling device and the working device are simultaneously operated, the present invention includes the sensing device for detecting the manipulation of the operation lever of the working device or the manipulation of the traveling pedal installed to the operation lever or traveling pedal, in which the sensing device outputs the electric signal to the controller in the specific operation mode, thereby minimizing the operation shock due to the sudden reduction of the traveling speed.

With the construction, the present invention has the following advantages.

Although the equipment is decelerated to some degree when the left and right traveling devices and the working device are simultaneously operated, the driver is not shocked by such sudden deceleration. Consequently, the manipulation is maintained, and the possibility of erroneous manipulation is minimized.

Also, when the load pressure of the working device is much higher than that of the traveling device, the hydraulic fluid to be supplied to the working device is not supplied to the traveling device, thereby preventing increase of the traveling speed that would cause operation shock.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A traveling system for heavy construction equipment, comprising:
first and second variable displacement hydraulic pumps driven by an engine and having the same maximum capacity;
electric proportional control valves controlling capacities of the hydraulic pumps;
a pilot pump feeding a pilot pressure to the electric proportional control valves;
a controller outputting an electric signal to the electric proportional control valves;
a main control valve that controls the flow direction of a hydraulic fluid discharged from the hydraulic pumps and includes left and right traveling spools connected to the hydraulic pumps that control the flow direction of a hydraulic fluid to be supplied to the left and right traveling motors by controlling startup/stop of the left and right traveling motors that drive a traveling device through left and right traveling operation pedals, at least one working device spool that controls the flow direction of a hydraulic fluid to be supplied to a working device by controlling startup/stop of a hydraulic actuator driving the working device through a working device operation lever, and a straight traveling spool that obtains straight drive of the equipment when the traveling device and the working device are simultaneously operated;
an electric control valve that feeds pilot pressure to the straight traveling spool to shift the straight traveling spool when the left and right traveling motors and the hydraulic actuator are simultaneously operated;
a sensing device detecting manipulation of the left and right traveling operation pedals to output an electric signal;
a sensing device detecting manipulation of the working device operation lever to output an electric signal; and
a mode selection device, installed to one side of the controller, for selecting a specific mode.

2. The traveling system as claimed in claim 1, wherein if a standard mode is selected by the mode selection device, the first hydraulic pump and the second hydraulic pump discharge the hydraulic fluid at a flow rate in proportion to manipulation amounts of the traveling operation pedals and the working device operation levers; if the traveling operation pedals and the working device operation levers are manipulated to an end of stroke, the hydraulic pumps discharge the hydraulic fluid at the maximum flow rate so that the traveling motor and the hydraulic actuator operate at the maximum speed; if a specific mode is selected by the mode selection device, the hydraulic pump discharges hydraulic fluid at a flow rate corresponding to the manipulation amount of the operation lever when only the traveling device is operated, while the hydraulic pump discharges the hydraulic fluid at a flow rate corresponding to the manipulation amount of the pedal when only the traveling device is operated; although the pedal or the operation lever is manipulated to the end of stroke, the hydraulic pump does not discharge the hydraulic fluid at the maximum discharge rate but discharges the hydraulic fluid at a predetermined discharge rate; and if the left and right traveling devices and the working device are simultaneously operated, the controller receives the signals from the sensing devices detecting manipulation of the left and right traveling operation pedals and the sensing devices detecting manipulation of the manipulation levers of the left and right traveling spool-side working devices and maximizes the discharge rate of the hydraulic fluid discharged from the hydraulic pumps.

3. The traveling system as claimed in claim 1, wherein if the straight traveling spool is in a neutral mode, one side of the supply ports of the main control valve is connected to the left traveling spool and the spool of the left traveling-side working device which is connected in series or in parallel with the left traveling spool, and the other side of the supply ports of the main control valve is connected to the right traveling spool and the spool of the right traveling-side working device which is connected in series or in parallel with the right traveling spool.

4. The traveling system as claimed in claim 1, wherein the sensing device for detecting manipulation of the traveling operation pedals is composed of a sensing device for detecting manipulation of the left traveling operation pedal, and a sensing device detecting manipulation of the right traveling operation pedal.

5. The traveling system as claimed in claim 1, wherein the sensing device for detecting manipulation of the traveling operation pedals is to detect manipulation of the left and right traveling operation pedals.

6. The traveling system as claimed in claim 1, wherein the sensing device for detecting the manipulation of the working device operation lever is to detect operation of the working device.

7. The traveling system as claimed in claim 1, wherein the sensing device for detecting the manipulation of the working device operation lever is to detect whether the working device spool is driven by at least one of the working device operation levers.

8. The traveling system as claimed in claim 1, wherein the sensing device for detecting manipulation of the traveling operation pedals and the sensing device for detecting the manipulation of the working device operation lever are to detect whether the left and right traveling operation pedals and at least one of the working device operation levers are simultaneously operated.

9. The traveling system as claimed in claim 1, 4, 5, 6, 7, or 8, wherein the sensing device comprises a pressure switch.

10. The traveling system as claimed in claim 1, 4, 5, 6, 7, or 8, wherein the sensing device comprises a pressure sensor.

11. The traveling system as claimed in claim 1, 4, 5, 6, 7, or 8, wherein at least one of the traveling operation pedals or working device operation levers uses an electric pedal or an electric operation lever, so that an output voltage of the pedal or operation lever is measured to detect manipulation of the traveling operation pedals or manipulation of the working device operation levers.

12. The traveling system as claimed in claim 1, wherein the electric control valve is a solenoid valve.

13. The traveling system as claimed in claim 1, wherein the electric control valve is an electric proportional valve.

14. A traveling method for heavy construction equipment, comprising:
selecting a standard mode by using a mode selection device;
when only a traveling device is operated, hydraulic fluid is supplied from a first hydraulic pump to a left traveling spool and also from a second hydraulic pump to a right traveling spool via a straight traveling spool, so that the first hydraulic pump and the second hydraulic pump discharge the hydraulic fluid at a flow rate in proportion to manipulation amounts of traveling operation pedals;
when only a working device is operated, hydraulic fluid is supplied from the first hydraulic pump to a spool for a left traveling-side working device and also from the second hydraulic pump to a spool for a right traveling-side working device via a straight traveling spool, so that the first hydraulic pump and the second hydraulic pump discharge the hydraulic fluid at a flow rate in proportion to manipulation amounts of working device operation levers;
when the traveling operation pedals and the working device operation levers are manipulated to an end of stroke, hydraulic fluid is discharged from the hydraulic pumps at the maximum flow rate so that a traveling motor and a hydraulic actuator operate at the maximum speed;
selecting a specific mode by using the mode selection device; and
discharging the hydraulic fluid at a flow rate corresponding to the manipulation amount of the operation lever if only the traveling device is operated, discharging the hydraulic fluid at a flow rate corresponding to the manipulation amount of the pedal if only the traveling device is operated, wherein although the pedal or the operation lever is manipulated to the end of stroke, the hydraulic pump does not discharge the hydraulic fluid at the maximum discharge rate but discharges the hydraulic fluid at a predetermined discharge rate, and if the left and right traveling devices and the working device are simultaneously operated, maximizing the discharge rate of the hydraulic fluid discharged from the hydraulic pumps when a controller receives signals from both the sensing devices detecting manipulation of the left and right traveling operation pedals and the sensing devices detecting manipulation of the manipulation levers of the left and right traveling spool-side working devices.
